(19) United States
(12) Patent Application Publication
(10) Pub. No.: US 2026/0287105 A1
(43) Pub. Date: Sep. 24, 2026

(54) PLUG-IN CONNECTOR FOR HOSE AND/OR PIPE CONNECTIONS WITH ASSEMBLY LOCK

(71) Applicant: VOSS Automotive GmbH, Wipperfürth (DE)

(72) Inventors: Eugen HEINRICHS, Bergneustadt (DE); Alexander OBERDÖRFER, Hückeswagen (DE); Markus WASCHKEWITZ, Bergneustadt (DE); Kazim CANPOLAT, Dormagen (DE); Adrian KLEHR, Soest (DE)

(21) Appl. No.: 19/570,815

(22) Filed: Mar. 18, 2026

(30) Foreign Application Priority Data
Mar. 18, 2025 (DE) 10 2025 110 430.1

(51) Int. Cl. F16L 37/12

(52) U.S. Cl. CPC F16L 37/1225

(57) ABSTRACT

The invention relates to a plug-in connector for hose and/or pipe connections, comprising a coupling part with a receiving opening, into which a plug part with a plug shaft can be inserted in an insertion direction along a plug axis, and a retaining clip that is U-shaped in its basic form and has four clip arms, which can be pre-assembled on the coupling part by radial insertion in an assembly direction. It is proposed that the retaining clip is a metallic bent-stamped part or an injection-molded part or molded part made of a high-performance plastic or of an organo sheet.

### BACKGROUND

The invention relates to a plug-in connector for hose and/or pipe connections, comprising a coupling part with a receiving opening into which a plug part with a plug shaft can be inserted in an insertion direction along a plug axis, and a radially slotted, at least partially spring-elastic retaining clip having four clip arms, which can be pre-assembled on the coupling part by radial insertion in an assembly direction, wherein the retaining clip assumes an insertion position for the plug part in a pre-assembly position, in which the plug part can be inserted into the receiving opening, and wherein the retaining clip assumes a holding position for the inserted plug part in an assembly position after insertion of the plug part, in which the plug part is positively blocked against withdrawal in the receiving opening by means of the retaining clip, and wherein the retaining clip is U-shaped in its basic form, and the legs of the U form two pairs of clip arms that are diametrically opposite each other, which are arranged one behind the other in the axial direction, are each separated from one another by a slot, and are spring-elastic in the radial direction.

Such a plug-in connector is known from DE 10 2019 111 199 A1. In this known plug-in connector, it is additionally provided that on a side of the first pair of latching arms facing the insertion direction of the plug part, which lies on a side of the retaining clip facing the insertion direction of the plug part, there are respective front inclined surfaces that diverge counter to the insertion direction of the plug part for interaction with the plug part. In the sense of making the plug system more flexible and in order to provide a plug-in connector that can be manufactured with little effort while having high functionality and simple assembly and disassembly, it is provided that the front inclined surfaces are each arranged on prongs of the first pair of latching arms directed radially inward - toward the plug axis - below the plug axis as viewed in the insertion direction of the retaining clip, wherein the prongs are spaced apart from one another such that the front inclined surfaces are spread apart by a sealing section of the plug part, which lies in the insertion direction in front of a collar of the plug part, when the plug part is inserted. The retaining clip, like the coupling part, can preferably be made of a technical plastic, in particular a fiber-reinforced one. In both the pre-assembly position and the assembly position, all legs of the retaining clip are immersed in the coupling part.

A plug-in connector of the type mentioned at the outset is also known from DE 10 2022 104 970 A1. The technical solution described therein relates to a plug-in connector for connecting a first fluid line to a mating connector, having a base body with a through-channel that is fluidically connected to an end of the base body designed as a socket section. In a receiving channel of the socket section - in contrast to the above-mentioned DE 10 2019 111 199 A1 - a clip cage is arranged, which can be inserted into the receiving channel of the socket section in an assembly direction and is held positively axially to the assembly direction. Two holding arms of a retaining clip running parallel to each other protrude into a through-opening of the clip cage in a rest state of the holding arms and are designed to be elastically expandable radially to the through-opening into a tension state. The retaining clip is designed to be displaceable between an insertion position and a blocking position, wherein the holding arms can be expanded into their tension state in the insertion position of the retaining clip and are blocked against expansion into the tension state in the blocking position of the retaining clip. The retaining clip has two bearing arms that are elastic radially to the through-opening, which positively fix the clip cage in the receiving channel and protrude into the through-opening in a rest state and are designed to be radially elastically expandable into a tension state. The implementation of a clip cage represents - in comparison with DE 10 2019 111 199 A1 - the use of an additional component and an additional assembly step.

A plug-in connector of the type mentioned at the outset (without an additional clip cage) is furthermore also known from WO 2017/067950 A1, wherein the technical solution described therein provides a plug-in connector in which both the pre-assembly process of the retaining clip and the assembly and disassembly process of the plug part are improved compared to the previously known prior art. In particular, the retaining clip can also be secured against loss. The pairs of clip arms lying axially one behind the other fulfill different functions. The first pair of latching arms fulfills a main function by positively blocking the plug part against withdrawal in the holding position, and the second pair of latching arms fulfills a secondary function by holding the retaining clip captively in the coupling part in both the pre-assembly position and the assembly position. In this known plug-in connector, in particular the pre-assembly position and the assembly position of the retaining clip coincide, i.e., the retaining clip is aligned coaxially with the axis of the coupling part in both positions - pre-assembly position and assembly position.

Plug parts, as mentioned at the outset, can be, for example, male plugs designed according to the SAE J 2044 standard, which are also described in detail in WO 2017/067950 A1. Such a plug part is designed in a hollow cylindrical shape. It has an insertion section, on the outer circumference of which a circumferential collar is arranged. The collar divides the insertion section into a sealing section and a locking section, wherein the sealing section is arranged axially, i.e., on the longitudinal axis of the plug part, in the insertion direction in front of the locking section. In the assembled state, the retaining clip engages behind the collar formed in the SAE plug contour. A sealing package usually sits on the sealing section after the plug is inserted.

Although the design of the retaining clips according to the above-mentioned documents is in some cases elaborate due to the various details to be precisely executed thereon, the mentioned plug system is nevertheless successfully used in automotive construction, particularly in fuel systems as well as in heated and unheated SCR systems. SCR stands for "Selective catalytic reduction" and refers to a technique for reduction of nitrogen oxides in exhaust gases.

DE 20 2019 002 026 U1 discloses a receiving nozzle of a connection that enables insertion of a plug nozzle with reduced force. This nozzle - like DE 10 2019 111 199 A1 - also has no clip cage, but a retaining ring is present, which is inserted into the main body of the nozzle on the side of a connection end of the nozzle and serves, among other things, to hold an O-ring in the main body. The ring is held in the main body by a U-shaped bridging clip with angled ends, which can be metallic and in particular formed from a wire and is inserted into recesses of the ring and the main body. Such a clip - often also referred to as a standard clip - which can also be used in other applications, has only one pair of opposing U-legs, in contrast to the mentioned retaining clips. A retaining clip as in the plug-in connector according to DE 10 2019 111 199 A1 is not present.

These and similar other fluidic plug-in connectors, such as according to EP 3 736 481 A1, including the mentioned standard clip, insofar as they can preferably be designed according to geometric specifications and dimensional standards of the German Association of the Automotive Industry (VDA) or are usually also designed accordingly, are referred to as coupling systems according to VDA standard. Their components can advantageously be universally combined due to the binding standard specifications.

EP 3 904 746 A1 describes a quick connector characterized in that it comprises a sleeve component and a sliding lock designed as a clip, wherein the sleeve component has a main body that defines a receiving hole for receiving a fluid line that can be inserted or is inserted therein in an axial direction and has an annular groove. The sliding lock extends in a transverse direction to the axial direction in an inner recess in the main body of the sleeve component and is configured to deform radially elastically toward the outside of the sleeve component during insertion of the fluid line through mechanical interaction with an end of the fluid line into the sleeve component, wherein it tends to move automatically in the transverse direction toward the inside of the sleeve component in response to the radial elastic deformation. The sleeve component further has a stop component that is designed to stop this automatically occurring movement of the sliding lock during insertion of the fluid line and to release a stop function of the sliding lock when the fluid line is fully inserted into the main body of the sleeve component. The sliding lock further comprises at least one locking hook that mates with a locking nose provided in the main body of the sleeve component, wherein the locking hook moves over the locking nose and finally encompasses it when the fluid line is fully inserted into the main body of the sleeve component.

US 2017/0146173 A1 also describes a known plug-in connector, similar to the type mentioned at the outset, with a clip cage, which however can also be made integrally with the coupling part with the receiving opening. The plug-in connector is - like that according to EP 3 904 746 A1 and that according to US 2021/301961 A1 discussed below - advantageously characterized by an automatic connection establishment - also referred to as "AutoLatch" - wherein, among other things, an important feature is also addressed to which high relevance is to be attributed in such plug connections.

This involves an indication of the plug state. For example, a U-shaped clip present in addition to a retaining clip can be provided for this purpose, which serves as an indicator for the state of assembly. When the plug is properly inserted into the socket, the clip initially protrudes from the plug connection, i.e., it is in a raised, high position, so that an operator can perform a first visual and/or tactile check to determine whether the plug connection is properly assembled. Thereafter, a second check is performed by a second operator, who in turn determines that the clip is in a protruding position and then manually pushes it into the plug connection so that it is no longer in the protruding position but in a low position. This two-stage check makes it possible to monitor the proper assembly of the coupling and thereby limit assembly errors on an assembly line, but it also requires two operators.

US 2021/301961 A1 describes a pipe connection device comprising a socket part into which a plug part can be inserted, which is provided with an annular groove. The socket part has two lateral slots. The device also comprises a U-shaped, preferably metallic, clip consisting of a head and two legs that span the socket part. Each leg protrudes into a lateral slot of the socket part and ends with an angled foot. Similar to US 2017/146173 A1, it also serves here as a plug indicator. Thus, the clip can in particular assume a raised position when no connection is present and a depressed position when a lock is present. Assuming an intermediate position, in which the clip is at a height between the two aforementioned positions, is also possible. The device further comprises a ring with two lateral openings facing the lateral slots of the socket part, as well as two lateral guide systems that cooperate with the feet of the clip to hold the clip in the raised or depressed position. Each guide system comprises a notch, a plate delimiting a lower edge of the notch, and a nose arranged on a flexible tab carried by the ring. The annular groove faces the lateral slots to enable the change of the clip between the depressed position and the raised position. The guide system represents an additional mechanism that makes the construction of the pipe connection device comparatively more complex.

### SUMMARY

The invention is based on the object of providing a plug-in connector of the type mentioned at the outset that can be manufactured with little effort while having high functionality and simple assembly, in particular automatic locking after insertion of a plug part. Furthermore, the plug-in connector should also enable simple, unambiguous and reliable indication of the plug state and be compatible with the geometric specifications and dimensional standards of the German Association of the Automotive Industry (VDA), preferably also executable using parts standardized according to VDA.

Accordingly, it is provided that the retaining clip is a metallic bent-stamped part or an injection-molded part or molded part made of a high-performance plastic or of an organo sheet. Here, according to the invention, low wear as well as high strength and toughness are combined with the optimal modulus of elasticity ranges for the required expandability of the clip arms, holding force and spring action of the retaining clip. In addition to stable and safe operation with the plug-in connector according to the invention, fracture-free assembly, disassembly and long-term reassembly capability are also ensured. The retaining clip can - compared to the retaining clip according to the prior art mentioned at the outset, since no pronounced inclined surfaces, prongs and/or guide pins as described there are required - have an optimally compact, space-saving form.

When the expressions "technical plastic" and "high-performance plastic" are used according to the application, they initially refer to a classification of plastics common in the professional world with regard to their continuous service temperature. According to this, a distinction is made between bulk or standard plastics with a continuous service temperature of up to 90 °C, technical plastics with a continuous service temperature of up to 140 °C, and high-performance plastics with a continuous service temperature above 140 °C. High-performance plastics generally also have high mechanical strengths.

The continuous service temperature can be determined in various ways. In the method according to UL 746 B, a so-called temperature index is specified, i.e., the temperature is determined at which the polymer material still has half of its tensile strength, its impact tensile strength or its electrical breakdown strength after 60,000 or 100,000 hours. An analogous method is IEC 216 (International Electrical Committee), which corresponds to DIN VDE 0304. According to this method, the temperature is determined at which the values of the mechanical and electrical properties are only half after 20,000 hours.

Based on these criteria, bulk plastics are classified in particular as polyethylene (PE), polypropylene (PP), polyvinyl chloride (PVC), polymethyl methacrylate (PMMA), acrylonitrile butadiene styrene (ABS) and polystyrene (PS).

Technical plastics include polyamide (PA), polyethylene terephthalate (PET), polybutylene terephthalate (PBT), polycarbonate (PC) and polyoxymethylene (POM).

High-performance plastics include polytetrafluoroethylene (PTFE), polyvinylidene fluoride (PVDF), polysulfones (PSU), polyaryletherketones (PAEK), polyphenylene sulfides (PPS), polyimides (PI) and polyphthalamides (PPA) as well as various copolymers that contain the smallest repeating chain structural units of the aforementioned compounds together. Since these high-quality polymers are very complex to produce and consequently expensive, their use is generally known to be limited to certain special cases.

However, polyamide composites, in particular glass fiber-filled polyamides (PA) with higher strength and thermal resistance compared to other polyamides having the properties of technical plastics, may also be suitable as materials for the retaining clip. In this respect, such materials are also subsumed under the term "high-performance plastic" according to the application.

Organo sheets are special fiber composite materials, in particular fiber-matrix semi-finished products. They consist of a fiber fabric or a fiber scrim embedded in a thermoplastic matrix. The advantages of the thermoplastic matrix lie in the hot-formability of the semi-finished products and the resulting shorter process times compared to conventional thermoset fiber composite materials. Frequently used fiber materials are glass, aramid and carbon. In fabrics and scrims, the fibers can also run perpendicular to each other, so that the mechanical properties of organo sheet such as stiffness, strength and thermal expansion can even be defined better than in their metallic counterparts. In contrast to metal sheets, the tensile and compressive behavior as well as other mechanical and thermal properties are not isotropic.

In an alternative manner, the object underlying the invention is achieved according to the invention by the features of the characterizing part of claim 7.

Accordingly, it is provided that the clip arms of the retaining clip are received both in the pre-assembly position and in the assembly position in respective grooves, which are at least partially slot-like and formed in the coupling part, which extend in the circumferential direction on the outside of the coupling part, wherein in the pre-assembly position

the clip arms of a first pair of clip arms, which face away from the plug part to be inserted, are not at all or only slightly radially expanded and accordingly are only under little or no radial tension, wherein these clip arms together with a web on the coupling part fix the retaining clip, and

the clip arms of a second pair of clip arms, which face the plug part to be inserted, are not at all or only slightly radially expanded and accordingly are not under radial mechanical tension, wherein the free ends of the clip arms at or in coupling part are guided,

and wherein in the assembly position

the clip arms of the first pair of clip arms, as in the pre-assembly position, are not at all or only slightly radially expanded and accordingly are only under little or no radial tension, wherein the free ends of the first pair of clip arms lie in a groove of the coupling part and are supported on the plug part,

the clip arms of the second pair of clip arms positively engage in the plug part, whereby the plug part is fixed in the coupling part, wherein the free ends of the second pair of clip arms lie on the outer circumference of the coupling part and are supported there,

wherein in the pre-assembly position a center axis of the retaining clip is arranged eccentrically to a transverse axis, in particular to a center axis of the coupling part, and in the assembly position the transverse axis of the retaining clip is arranged concentrically to the center axis of the coupling part.

With regard to the design of the retaining clip according to the invention, it is extremely advantageous in terms of manufacturing and assembly technology if the retaining clip is designed symmetrically with respect to a longitudinal axis passing through it. In this case, it can be provided in particular that the respective legs of the U of the first pair of clip arms are each designed to be rectilinear at the ends and each have a concavely (outwardly curved) circular arc-shaped section in the middle - as viewed from the longitudinal axis - while the respective legs of the U of the second pair of clip arms are designed to be substantially rectilinear over their entire length. This implies that their width can be variable. For the retaining clip used according to the invention, it is possible to use it instead of a so-called VDA standard clip together with a coupling part that corresponds to the geometric specifications and dimensional standards of the German Association of the Automotive Industry. It is advantageous that the retaining clip used according to the invention, in contrast to a VDA standard clip, ensures an unambiguous indication of the plug state.

As in the prior art, the pairs of clip arms lying axially one behind the other fulfill different functions according to the invention, although the manner in which these functions are fulfilled differs from the prior art in detail. The pair of clip arms facing the plug part during insertion serves to fulfill the main function of establishing the connection and securing the plug connection in the assembly position, i.e., for radially latching the plug part in the coupling part by means of the retaining clip, while the pair of clip arms facing away from the plug part during insertion serves to control the function of the automatic retraction of the retaining clip when the plug part is inserted into the coupling part. A clip cage as in the prior art is not necessary.

In addition, the first pair of clip arms facing away from the plug part during insertion serves in the pre-assembly position to fix the retaining clip on the coupling part, whereby advantageously a stable delivery state of the assembly unit is already represented. In the coupling part, in particular in its base body, a sealing package, but at least an elastomeric O-ring seal, can be arranged, which is held in the receiving opening by a socket ring.

Since in the pre-assembly position the center axis of the retaining clip is arranged eccentrically to a center axis of the coupling part, the retaining clip protrudes radially relative to the coupling part, whereby it is indicated in a simple manner that the assembly position has not yet been reached.

The pair of clip arms facing the plug part during insertion can also advantageously assume a function for indicating the plug state in a simple manner, insofar as it can preferably be provided that in the assembly position, when the clip arms of the second pair of clip arms positively engage in the plug part, a marking, in particular a printed barcode or QR code/DMC, on the outer circumference of the coupling part is exposed by at least one clip arm of the second pair, wherein this marking is at least partially covered by the clip arms of the second pair of clip arms in the pre-assembly position. For covering, for example, an angled end piece can serve, which is located at a free end of at least one clip arm.

Further advantageous embodiments of the invention result from the following description of the figures and the dependent subclaims.

### BRIEF DESCRIPTION OF THE DRAWINGS

FIG. 1 is a perspective three-dimensional exploded view of a preferred embodiment of a plug-in connector according to the invention, including a plug part.

FIGS. 2a to 2d is the first embodiment of a plug-in connector according to the invention shown in FIG. 1 in a pre-assembly position, in front view (FIG. 2a), in longitudinal section along line A-A in FIGS. 2a (2b), in cross-section along line B-B in FIGS. 2a (2c) and in cross-section along line C-C in FIGS. 2a (2d).

FIGS. 3a to 3d is the first embodiment of a plug-in connector according to the invention shown in FIG. 1 in a first intermediate position during assembly, in front view (FIG. 3a), in longitudinal section along line D-D in FIGS. 3a (3b), in cross-section along line E-E in FIGS. 3a (3c) and in cross-section along line F-F in FIG. 3a (FIG. 3d).

FIGS. 4a to 4d is the first embodiment of a plug-in connector according to the invention shown in FIG. 1 in a second intermediate position during assembly, in front view (FIG. 4a), in longitudinal section along line H-H in FIGS. 4a (4b) in cross-section along line G-G in FIGS. 4a (4c) and in cross-section along line I-I in FIGS. 4a (4d).

FIGS. 5a to 5d is the first embodiment of a plug-in connector according to the invention shown in FIG. 1 in the assembly position, in front view (FIG. 5a), in longitudinal section along line M-M in FIGS. 5a (5b), in cross-section along line N-N in FIGS. 5a (5c) and in cross-section along line O-O in FIGS. 5a (5d).

FIGS. 6a to 6d is a retaining clip of the embodiment of a plug-in connector according to the invention shown in FIG. 1, in front view (FIG. 6a), in side view (FIG. 6b), in plan view (FIG. 6c) and in three-dimensional perspective representation (FIG. 6d).

In the various figures of the drawing, identical parts are always provided with the same reference numerals and are therefore generally described only once below. However, for the sake of better clarity, not all parts are designated with their reference numerals in all figures of the drawing.

### DETAILED DESCRIPTION

With regard to the following description, it is claimed that the invention is not limited to the exemplary embodiment and thereby not to all or several features of described feature combinations; rather, each individual partial feature of the exemplary embodiment is also significant for the subject matter of the invention independently of all other partial features described in connection therewith.

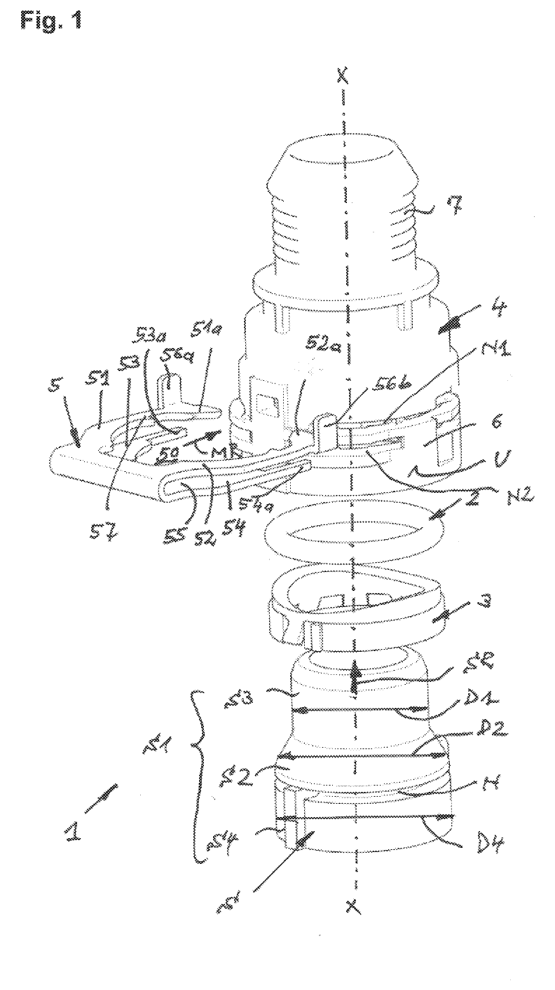

FIG. 1 shows an exploded view of an advantageous embodiment of a plug-in connector 1 according to the invention for connecting a plug part S designed as a pipe stub. Such a plug S is also shown in FIG. 1 - in a coaxial position with respect to the longitudinal axis X-X with the plug-in connector 1 according to the invention.

The plug part S is designed in a hollow cylindrical shape and has an insertion section (plug shaft S1), on the outer circumference of which a circumferential section S2 that widens conically counter to the insertion direction and has an enlarged diameter D2 compared to the remaining insertion section (base diameter D1) is arranged. The conical section S2 divides the insertion section S1 into a sealing section S3 and a locking section S4, wherein the sealing section S3 is arranged axially (longitudinal axis X-X) in the insertion direction SR in front of the locking section S4. A circumferential groove N is located in the locking section S4. The sealing section S3 has a smaller diameter, namely the base diameter D1 of the insertion section S1, than the diameter D4 of the locking section S4. After the plug S is inserted, a sealing package belonging to the plug-in connector 1 or - as shown - an O-ring seal 2 sits on the sealing section S3. A socket ring 3 also belonging to the plug-in connector 1 serves to hold the sealing package or the O-ring seal. The individual sections of the plug S - insertion section S1, comprising the sealing section S3, the conical section S2 and the locking section S4 - are designated with reference numerals only in FIG. 1 for the sake of clarity.

The plug-in connector 1 further comprises a coupling part 4 and an at least partially spring-elastic retaining clip 5.

The coupling part 4 has a base body 6, designed in particular as a socket part, which functions as a receiving body for the retaining clip 5. The base body 6 can advantageously preferably be designed in a simple manufacturing design as an injection-molded part made of plastic, wherein the coupling part 4 can consist in particular of a technical plastic such as polymethyl methacrylate (PMMA), polyethylene terephthalate (PET), polycarbonate (PC), acrylonitrile butadiene styrene (ABS), polyoxymethylene (POM) or polyamide (PA), in particular glass fiber-filled polyamide. For higher temperature loads, polyphthalamides (PPA) in particular are also considered suitable.

The coupling part 4 can be connected on one side to a fluid line (not shown). For this purpose, a connection section 7 is formed on the base body 6, which is shown exemplary in a design for mandrel attachment. A media line to be connected can be designed in particular as a hose or pipe.

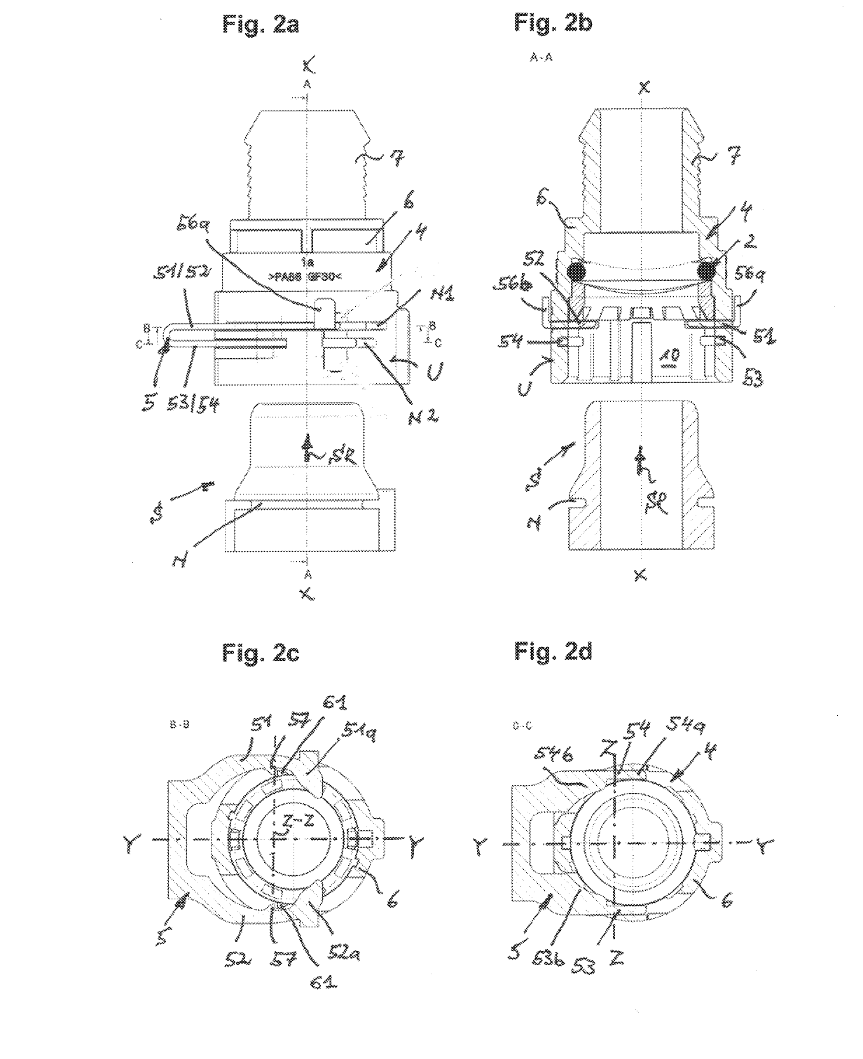

On the side opposite the connection section 7 for the media line, the coupling part 4 has a receiving opening for inserting the plug part S. This is designated with reference numeral 10 in FIGS. 2b, 3b, 4b and 5b.

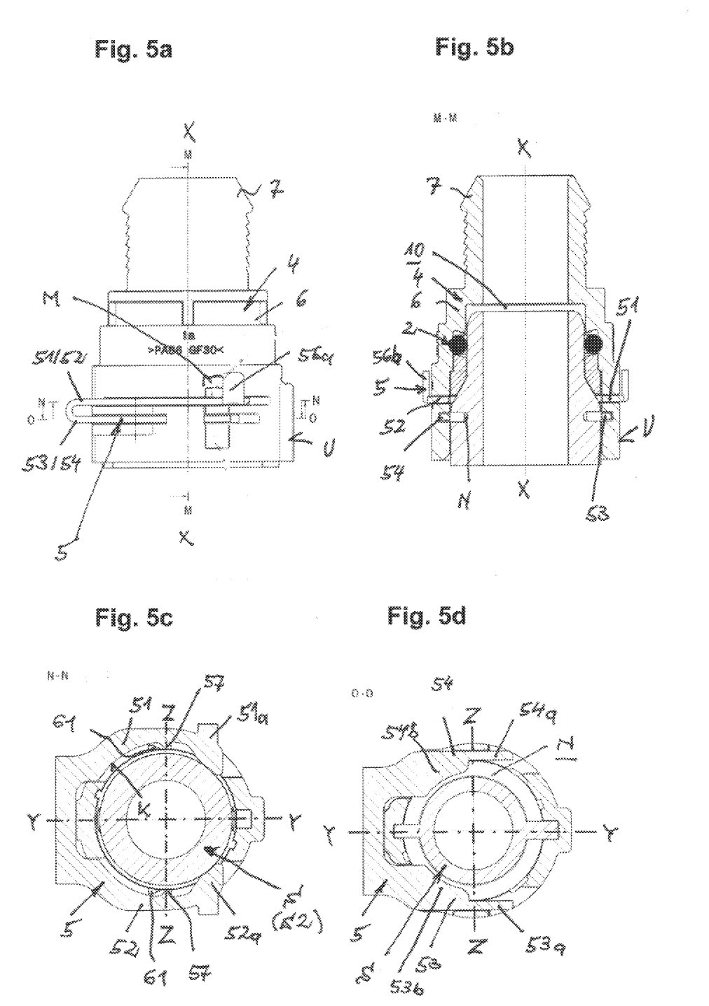

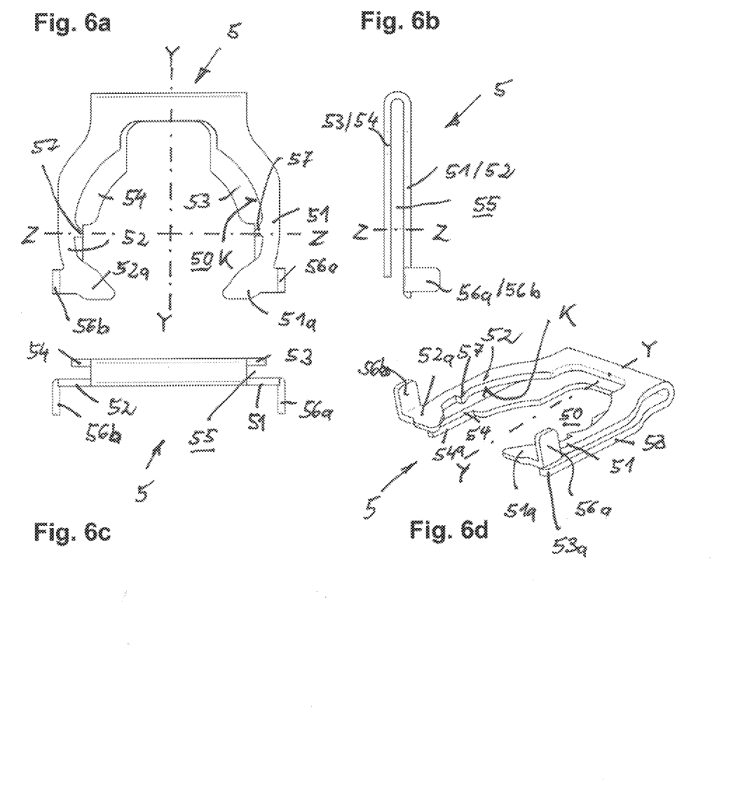

The retaining clip 5 - individual views are shown in FIG. 6a to 6d - can be pre-assembled on the coupling part 4 and assumes the pre-assembly position shown in FIGS. 2a to 2d after radial insertion in the assembly direction MR, which represents the insertion position for the plug part S. The pre-assembly position of the retaining clip 5 is only completely released when the plug part S is fully inserted into the coupling part 4 and the assembly position is reached, which is shown in FIGS. 5a to 5d.

In the assembly position, the retaining clip 5 assumes a holding position for the inserted plug part S after insertion of the plug part S, in which the plug part S is positively blocked against withdrawal in the receiving opening 10 by means of the retaining clip 5.

The retaining clip 5 has two pairs 51/52, 53/54, i.e., four, at least partially spring-elastic clip arms 51, 52, 53, 54 with free ends 51a, 52a, 53a, 54a. In each pair of clip arms 51/52, 53/54, these clip arms 51, 52, 53, 54 are each separated from one another by a radial slot 50. The clip arms 51, 52, 53, 54 form spring-elastic regions of the retaining clip 5 and are spring-elastic in particular in the radial direction. "Slot 50" is understood to mean the entire intermediate space forming the interior of the U, surrounding the plug axis X-X, lying between the clip arms 51 and 52 as well as 53 and 54.

With regard to the radial insertion of the retaining clip 5 in the pre-assembly direction MR, it should be noted that this - in contrast to the prior art, more precisely - is only to be regarded as a sliding of the retaining clip 5 onto the coupling part 4, since the free ends 51a, 52a, 53a, 54a of the clip arms 51, 52, 53, 54 never completely immerse into the interior of the base body 6 of the retaining clip 5.

The retaining clip 5 is U-shaped in its basic form, and the legs of the U form the two pairs 51/52, 53/54 of diametrically opposite clip arms 51, 52, 53, 54, which are arranged one behind the other in the axial direction X-X, wherein they are also separated from one another in this direction by a slot (axial slot 55).

The clip arms 51, 52, 53, 54 of the retaining clip 5 are - both in the pre-assembly position and in the assembly position - each received in at least partially slot-like grooves N1, N2 formed in the coupling part 4, which extend in the circumferential direction on the outside of the coupling part 4.

In the pre-assembly position - see FIGS. 2a to 2d - the clip arms 51, 52 of the first pair 51/52 of clip arms, which face away from the plug part S to be inserted, are under little or no radial mechanical tension, which was generated by the radial expansion of the clip arms 51, 52 during pre-assembly and a subsequent springing back, wherein the free ends 51a, 52a of these clip arms 51, 52 lie on the outside on the coupling part 4, whereby the retaining clip 5 is fixed on the coupling part 4. After expansion for sliding the retaining clip 5 onto the coupling part 4, the clip arms 51, 52 are no longer or only slightly radially expanded according to the geometry (depth, slot length) of the groove N1 receiving them in the pre-assembly position. This is advantageous because relaxation and flow processes can thereby be prevented.

The clip arms 53, 54 of the second pair 53/54 of clip arms, which face the plug part S to be inserted, are not radially expanded and are also not under radial tension, wherein the free ends 53a, 54a of these clip arms lie freely in a groove N2 on the outer circumference U of the coupling part 4. However, due to the position of the first pair of clip arms 51/52 and due to the guidance of all clip arms 51, 52, 53, 54 in the grooves N1, N2 formed in the coupling part 4, the retaining clip 5 is sufficiently secured for captive retention on the coupling part 4. It is advantageous if an angled end piece 56a, 56b is located at a free end 51a, 52a, 53a, 54a of at least one clip arm 51, 52, 53, 54. In the illustrated embodiments - as can be seen from the drawing - angled end pieces 56a, 56b that are angled in the axial direction X-X are located on the clip arms 51, 52 of the first pair 51/52, which faces away from the plug part S. As FIG. 6a to 6d show, these angled end pieces 56a, 56b can also be designed in a planar shape. The free ends 51a, 52a on the clip arms 51, 52 of the pair 51/52 can preferably be designed in a nose shape for a particularly locking engagement in the coupling part 4. The free ends 53a, 54a of the other pair of clip arms 53/54 terminate in a rectilinear manner.

In the assembly position - see FIGS. 5a to 5d - the clip arms 51, 52 of the first pair 51/52 of clip arms are under less radial tension than in the pre-assembly position, wherein the free ends 51a, 52a of the first pair 51/52 of clip arms lie on the outer circumference U of the coupling part 4 and are supported there. They can even be completely tension-free. The clip arms 51, 52 have been raised relative to the coupling part 4 during assembly under the effect of the inserted plug part S, in particular through interaction with its conical section S2, and then sprung radially inward. The latter is shown in particular in FIG. 5c. The plug connection S/4 is functional in this state.

The clip arms 53, 54 of the second pair 53/54 of clip arms thereby positively engage, in particular in a tension-free manner, in the plug part S, in particular in its groove N, whereby the plug part S is fixed in the coupling part 4, wherein the free ends 53a, 54a of the second pair 53/54 of clip arms still lie on the outer circumference U of the coupling part 4 and are supported there. This is shown in particular in FIG. 5d.

In the pre-assembly position, a transverse axis Z-Z, in particular a center axis, of the retaining clip 5 is arranged eccentrically to the center axis X-X of the coupling part 4, and in the assembly position the transverse axis Z-Z of the retaining clip 5 is arranged concentrically to the center axis X-X of the coupling part 4. Since in the pre-assembly position the transverse axis Z-Z of the retaining clip 5 is arranged eccentrically to the center axis X-X of the coupling part 4, the retaining clip 5 protrudes circumferentially radially noticeably beyond the outer circumference U of the coupling part 4, whereby it is indicated in a simple but clear and unambiguous manner that the assembly position has not yet been reached, in which the transverse axis Z-Z of the retaining clip 5 (see in particular FIG. 5c and also FIG. 6b) and the center axis X-X of the coupling part 4 coincide and the retaining clip 5 protrudes little or not at all beyond the circumference U of the coupling part 4, i.e., almost flush, which indicates that the locked assembly state has been reached. Advantageously, manual pressing in of the retaining clip 5 and a double operator check, as described in the prior art, are thereby eliminated.

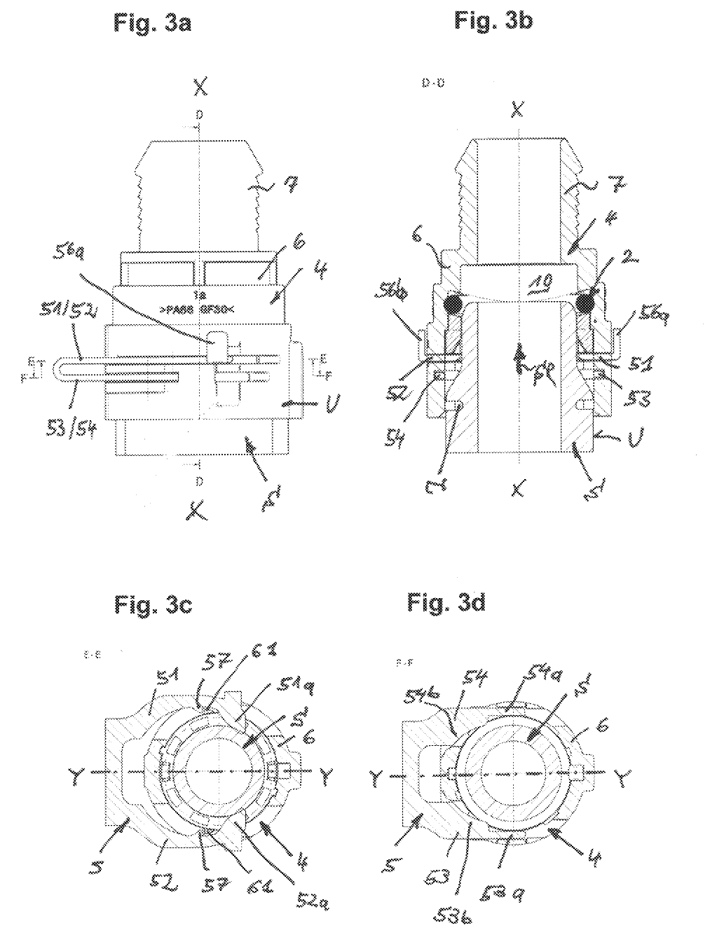

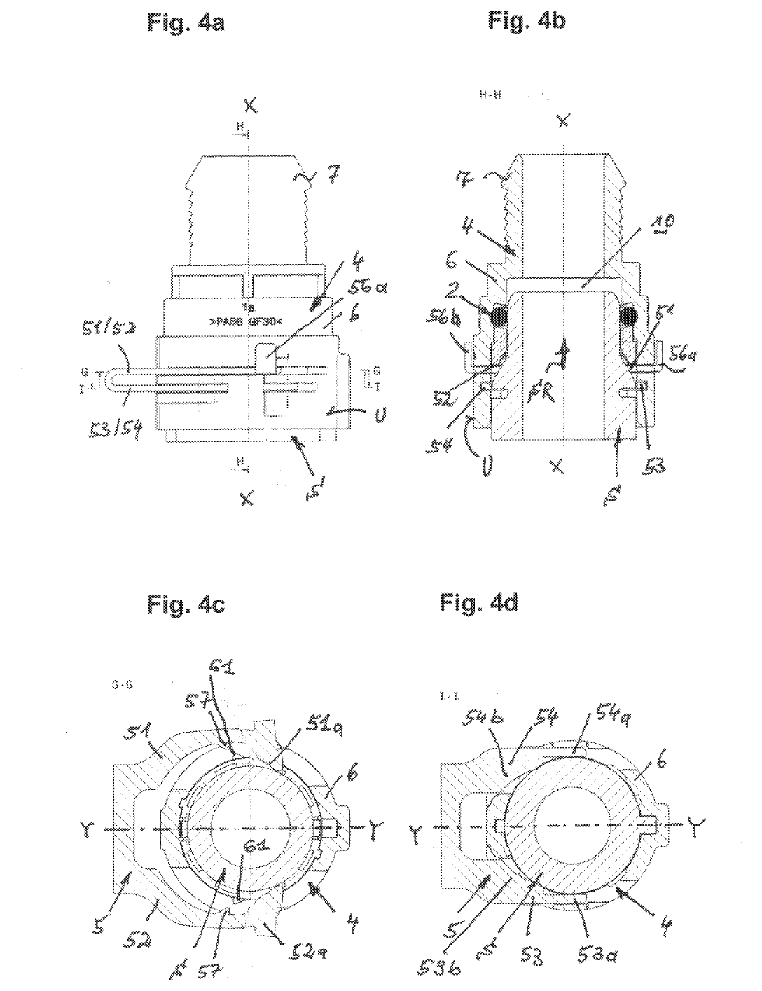

FIGS. 3a to 3d as well as FIGS. 4a to 4d depict individual phases of the assembly process between the pre-assembly position (FIGS. 2a to 2d) and the assembly position (FIGS. 5a to 5d).

In particular from the sequence of figures of the sectional views 2b, 3b, 4b, 5b, it can be clearly seen how the plug part S penetrates ever deeper into the coupling part 4. This can be realized, for example, by manual plugging or, if applicable, advantageously also in an automated manner. The conical section S2 of the plug part S thereby successively expands the pair 51/52 of clip arms more and more under the effect of an insertion force, until through this spreading an enlarged diameter D2 of the conical section S2 compared to the base diameter D1 raises the first pair 51/52 at least slightly above the circumference U of the coupling part 4, wherein simultaneously or slightly later the plug part S reaches a position relative to the second pair 53/54 in which the clip arms 53, 54 can slide radially into the groove N of the locking section S4 for locking. Thus, the free ends 51a, 52a of the arms 51, 52, which are expanded by the conical part S2 of the plug part S, release the previously built-up radial tension by sliding on the radius of the conical section S2 of the plug S in such a way that the retaining clip 5 is retracted radially. In particular, the nose-shaped ends 51a, 52a of the first pair 51/52 of clip arms thus provide for the retraction movement of the clip 5. This then guides a respective rear section 53b, 54b of the clip arms 53, 54 of the second pair 53/54 of clip arms, which is wider than the free ends 53a, 54a, into the groove N of the plug S.

All these movements of the clip arms 51, 52, 53, 54 advantageously take place automatically, i.e., exclusively under the effect of the insertion of the plug part S, which can also be referred to as an "AutoLatch" function.

In addition, the reaching of the locked assembly state can advantageously also be additionally indicated in that in the assembly position, when the clip arms 53, 54 of the second pair 53/54 of clip arms positively engage in the plug part S, a marking M, which can in particular be a printed barcode or QR code/DMC, on the outer circumference U of the coupling part 4 is exposed by at least one clip arm 51, 52 of the first pair 51/52 (see FIG. 5a), wherein in a manner not shown here this marking M is at least partially covered by the at least one clip arm of the first pair 51/52 of clip arms, preferably by tabs 56a, 56b, in the pre-assembly position (FIG. 2a) and before completion of assembly (FIG. 3a and 4a). This enables digitized monitoring.

As shown in particular in the individual part views in FIG. 2a to 6d, the retaining clip 5 is designed symmetrically with respect to a longitudinal axis Y-Y passing through it. As already mentioned, the retaining clip 5 is U-shaped in its basic form - as viewed in the direction of the longitudinal axis X-X of the plug-in connector 1 - wherein the legs of the U form the pairs 51/52, 53/54 of diametrically opposite clip arms 51, 52, 53, 54. The clip arms 51, 52, 53, 54 form in particular spring-elastic regions of the retaining clip 5. The legs of the U are each separated radially by a slot 50 and also axially by a slot 55.

The legs of the U of the second pair 53/54 of clip arms can be designed to be substantially rectilinear, i.e., at least on the outside, over their entire length, while the legs of the U of the first pair 51/52 of clip arms each have a concavely circular arc-shaped section K in the middle with respect to the longitudinal axis Y-Y. This is illustrated particularly clearly in FIG. 6a. A retaining tooth 57 can also be located there, which protrudes less radially inward than the noses in the free end regions 51a, 52a of the clip arms 51, 52.

The rectilinear course of the legs of the U of the second pair 53/54 of clip arms does not preclude that the wider sections 53b, 54b of the legs 53, 54 on the side facing away from the free ends 53a, 54a are each wider than at the free ends 53a, 54a in the sense of increased stability and secure assembly, as shown in particular in FIGS. 2d, 3d, 4d and 5d.

With regard to the technical significance of the concavely circular arc-shaped section K of the first pair 51/52 of clip arms, reference is made by way of example to FIG. 5c, from which it can be seen that this concavely circular arc-shaped section K can advantageously preferably rest positively, in particular in the conical section S2 that widens counter to the insertion direction SR, including the tooth 57 preferably located there, against the outer circumference of the assembled plug part S during the transition to the assembly position, whereby the above-mentioned preferably mechanically tension-free state of the clip arms 51, 52 can be achieved for the first pair 51/52 of clip arms in the assembly position.

The retaining teeth 57 can thereby have a fixing effect in the pre-assembly position. For this purpose, the retaining teeth 57 are supported on corresponding webs 61 on the base body 6 of the coupling part4 until the clip arms 51, 52 of the retaining clip 5 have been sufficiently expanded by the conical section S2 of the plug part S. They then release the radial retraction movement of the clip 5 by bringing the respective retaining tooth 57 and web 61 out of engagement. The main task of the retaining teeth 57 is thus to prevent the retaining clip 5 from being accidentally pressed in when no plug S is yet arranged in the receiving opening 10 of the coupling part 4 or has not yet been pushed in far enough (see FIG. 2c).

The transverse axis Z-Z or center axis, through whose relative arrangement to the longitudinal axis X-X of the coupling part 4 the eccentric or concentric position of the retaining clip 5 relative to the coupling part 4 can be defined, extends substantially through the center points of the concavely circular arc-shaped sections K of the opposing clip arms 51, 52.

The design of the retaining clip 5 itself - in particular according to FIGS. 6a to 6d - is also attributed inventive significance.

The invention is not limited to the illustrated and described exemplary embodiment, but also encompasses all embodiments having the same effect within the meaning of the invention. It is also expressly emphasized that the exemplary embodiment is also not limited to all of its features in combination; rather, each individual partial feature can also have inventive significance independently of all other partial features.

Furthermore, the invention is also not yet limited to the feature combinations defined in claims 1, 7 and 14, but can also be defined by any other combination of certain features of all individually disclosed features. This means that in principle practically any individual feature of the independent claims can be omitted or replaced by at least one individual feature disclosed elsewhere in the application.

What is claimed is:

1. A plug-in connector for hose and/or pipe connections, comprising a coupling part with a receiving opening, into which a plug part with an insertion section can be inserted in an insertion direction along a plug axis, and a radially slotted, at least partially spring-elastic retaining clip having four clip arms, which can be pre-assembled on the coupling part by radial insertion in an assembly direction, wherein the retaining clip assumes an insertion position for the plug part in a pre-assembly position, in which the plug part can be inserted into the receiving opening through the retaining clip, and wherein the retaining clip assumes a holding position for the inserted plug part in an assembly position after insertion of the plug part, in which the plug part is positively blocked against withdrawal in the receiving opening by means of the retaining clip, wherein the retaining clip is U-shaped in its basic form, and legs of the U form a first pair and a second pair of diametrically opposite clip arms, which are arranged one behind the other in an axial direction, are each separated from one another by a slot, and are spring-elastic in a radial direction, wherein the retaining clip is a metallic bent-stamped part or an injection-molded part or molded part made of a high-performance plastic or of an organo sheet.

2. The plug-in connector according to claim 1, wherein the retaining clip is designed symmetrically with respect to a longitudinal axis passing through it.

3. The plug-in connector according to claim 1, wherein the legs of the U of the second pair of clip arms are designed to be substantially rectilinear over their entire length.

4. The plug-in connector according to claim 1, wherein the legs of the first pair of clip arms are each designed in a nose shape at the ends and each have a concavely circular arc-shaped section in the middle with respect to the longitudinal axis.

5. The plug-in connector according to claim 1, wherein a radially inwardly pointing retaining tooth is arranged on each of the legs of the first pair of clip arms, in particular in the concavely circular arc-shaped section, wherein a corresponding web on the base body of the coupling partis assigned to each retaining tooth, against which the retaining tooth rests in the pre-assembly position, whereby radial insertion of the retaining clip into the coupling part is prevented when no plug part is located in the coupling part, wherein upon radial expansion of the legs of the first pair of clip arms by the plug part, the retaining tooth releases a radial retraction movement of the retaining clip into the coupling part.

6. The plug-in connector according to claim 1, wherein an axially angled end piece is located at a free end of at least one clip arm, preferably at a pair of clip arms.

7. The plug-in connector according to claim 1, wherein the clip arms of the retaining clip are received both in the pre-assembly position and in the assembly position in respective grooves, which are at least partially slot-like and formed in the coupling part, which extend in the circumferential direction on the outside of the coupling part,
wherein in the pre-assembly position
the clip arms of the/of a first pair of clip arms, which face away from the plug part to be inserted, are not at all or only slightly radially expanded and accordingly are only under little or no radial mechanical tension, wherein these clip arms together with a web on the coupling part the retaining clip on the coupling part fix, and
the clip arms of the/of a second pair of clip arms, which face the plug part to be inserted, are not at all or only slightly radially expanded and accordingly are not under radial mechanical tension, wherein the free ends of the clip arms at or in the coupling part are guided,
and wherein in the assembly position
the clip arms of the first pair of clip arms, as in the pre-assembly position, are not at all or only slightly radially expanded and accordingly are only under little or no radial tension, wherein the free ends of the first pair of clip arms lie in a groove of the coupling part and are supported on the plug part,
the clip arms of the second pair of clip arms positively engage in a groove of the plug part, whereby the plug part is fixed in the coupling part,
wherein in the pre-assembly position a transverse axis of the retaining clip is arranged eccentrically to a center axis of the coupling part and in the assembly position the transverse axis of the retaining clip is arranged substantially concentrically to the center axis of the coupling part.

8. The plug-in connector according to claim 1, wherein in the pre-assembly position a marking, in particular a printed barcode or QR code/DMC, on the outer circumference of the coupling part is at least partially covered by at least one clip arm, in particular of the first pair of clip arms, and is exposed in the assembly position.

9. The plug-in connector according to claim 1, wherein the coupling part has a base body designed as a socket part, in particular a one-piece base body, which is designed as an injection-molded part made of plastic.

10. The plug-in connector according to claim 1, wherein the plug part is designed in a hollow cylindrical shape and has an insertion section (S1) that comprises a circumferential section that widens conically counter to the insertion direction, which divides the insertion section into a sealing section and a locking section, wherein the sealing section is arranged axially, i.e., on the longitudinal axis of the plug part, in the insertion direction in front of the locking section.

11. The plug-in connector according to claim 10, wherein the retaining clip in the assembly position, in particular the second pair of clip arms thereof, preferably with sections that are wider compared to the free ends thereof, engages in a groove in the locking section behind the section that widens conically counter to the insertion direction.

12. The plug-in connector according to claim 6, wherein in the assembly position the first pair of clip arms with the respective concavely circular arc-shaped section surrounds the conical section of the plug part.

13. The plug-in connector according to claim 10, wherein in the assembly position a sealing package or at least one O-ring seal and a socket ring for holding the sealing package or the at least one O-ring seal are arranged on the plug part, in particular on the sealing section thereof.

14. The plug-in connector according to claim 1, wherein in the assembly position a sealing package or at least one O-ring seal and a socket ring for holding the sealing package or the at least one O-ring seal are arranged on the plug part, in particular on the sealing section thereof.

15. A retaining clip for a plug-in connector for hose and/or pipe connections, the plug-in connector including a coupling part with a receiving opening into which a plug part with an insertion section can be inserted in an insertion direction along a plug axis, the retaining clip comprising a radially slotted, at least partially spring-elastic body having four clip arms, the retaining clip being configured to be pre-assembled on the coupling part by radial insertion into a pre-assembly position permitting insertion of the plug part into the receiving opening through the retaining clip, the retaining clip configured to assume a holding after insertion of the plug part in which the plug part is positively blocked against withdrawal from the receiving opening by means of the retaining clip, wherein the retaining clip is U-shaped having legs forming a first pair and a second pair of diametrically opposite clip arms, the first and second pair of clip arms being arranged one behind the other in an axial direction and being separated from one another by a slot, the first and second pair of clip arms being spring-elastic in a radial direction, the retaining clip being a metallic bent-stamped part or an injection-molded part or molded part made of a high-performance plastic or of an organo sheet.

16. The retaining clip according to claim 15, wherein the retaining clip is symmetrical with respect to a longitudinal axis passing through the retaining clip.

17. The retaining clip according to claim 15, wherein the legs defined by the second pair of clip arms are substantially rectilinear over their entire length.

18. The retaining clip according to claim 15, wherein each of the legs of the first pair of clip arms terminate in a nose shape at ends thereof and each have a concavely circular arc-shaped section in the middle with respect to the longitudinal axis.

19. The retaining clip according to claim 15, wherein each of the legs of the first pair of clip arms includes a radially inwardly pointing retaining tooth, in particular in a concavely circular arc-shaped section, wherein a corresponding web on the base body of the coupling partis assigned to each retaining tooth, against which the retaining tooth rests in the pre-assembly position, whereby radial insertion of the retaining clip into the coupling part is prevented when no plug part is located in the coupling part, wherein upon radial expansion of the legs of the first pair of clip arms by the plug part, the retaining tooth releases a radial retraction movement of the retaining clip into the coupling part.

20. The retaining clip according to claim 15, wherein an axially angled end piece is located at a free end of the first pair of clip arms.
